(19) United States
(12) Patent Application Publication
(10) Pub. No.: US 2005/0037046 A1
(43) Pub. Date: Feb. 17, 2005

(54) Fish attractant and applicator

(76) Inventors: Ken Braun, Holbrook, NY (US); Michael DePalma, Bluepoint, NY (US)

Correspondence Address: Attn: Thomas A. O'Rourke;Bodner & O'Rourke, Ste 108, 425 Broadhollow Road, Melville, NY, 11747, US

(21) Appl. No.: 10/859,050

(22) Filed: Jun. 1, 2004

Related U.S. Application Data
(60) Provisional application No. 60/491,545, filed on Jul. 31, 2003.

(51) Int. Cl. A01K 1/00

(52) U.S. Cl. 424/410

(57) ABSTRACT

A fish attractant composition is disclosed. The composition may include a Gelling Agent, an Emulsifier, a Humectant, an Emollient and an Active Agent. Other ingredients can include one or more Amino acids as well as some Hamamelis Virginiania. The fish attractant of the present invention forms a soft semi solid consistence that may be applied by rubbing with an applicator onto the article that the fish is to be attracted to such as a hook, lure, the string etc.

### BACKGROUND OF THE INVENTION

Hunting and fishing aids and equipment for outdoorsmen have come a long way over the years. There are countless methods and devices used in hunting wild game including the sport of fishing. Hunters have improved upon traps, riflery and other methods of capturing prey. Fishermen have advanced the use of rods and reels, different baits lures and hooks. Both groups seek advantages that will allow them to track and capture wild game easier and more successfully.

In capturing prey, such as deer, elks and geese, hunters have made advances in riflery by employing different scopes and ammunition. Also, hunters have become more adept at trapping particularly humane trapping. In tracking game, hunters have used various types of camouflage calls and scents. Camouflage allows the hunters to look like part of the natural environment; thus, allowing him or her to get closer to the animal. Hunters will also employ different scents to simulate animals in a herd or waiting to be mated with. Along the same lines, hunters use calls to attract game. For example, bird and moose calls have long been used by hunters.

Fishing presents a more difficult challenge, particularly because the medium of water is harder to control than an open-air environment. However, even fishermen have available to them significant improvements in equipment and techniques used to capture the fish.

More durable rods and reels have been manufactured. Different materials have been used. Some are stronger, others are more flexible. Some are more resistant to the effects of moisture, particularly salt water. Additionally, the fishing line used by many fisherman has been constructed to last longer and have higher tensile strength to prevent tearing, ripping and snapping and thus loss of the fish.

Different techniques of fishing have been developed according to the different types of fish. There are many types of specialized equipment that have been developed to aid the fisherman. For example, fly-fishing is a method of fishing for fresh-water fish, such as salmon, in a stream. There are special rods and reels as well as artificial flies that are available. Ocean fishing employs different equipment because of the types of fish and the corrosive nature of sale water. Also, boaters have available to them many methods when searching for fish, such as flounder or fluke. Fishermen some times use a technique called trolling to catch blue fish and marlin.

Though the devices used by fishermen have advanced greatly, effective methods of attracting fish are elusive. Today, some fishing boats use sonar equipment to detect the approximate number of fish below the boat. A sound wave is bounced off the ocean floor and the signal that returns notifies the fishermen of the type and number of fish below the boat. Sonar equipment is very expensive and often complicated.

Thus, fishermen have tried to develop more enticing lures that will attract fish. Many lures employ reflective objects that spin in the water creating an array of light that may entice the fish. Other lures are made to look like live bait that is often used, such as earthworms, squid or crabs. Sometimes lures are used in conjunction with scents. However, most of these scents that are desirable to the fish do not always present a desirable odor to the fisherman, making them difficult to work with and to store. In using many of these scents, the fishermen must rub the scented mixture or compound on the lure. Many lures are made of materials that are impermeable to the scent that is being applied and it is not uncommon for the scent to rub off and thus, there is a need for the fisherman to have to reapply the scent many times during an afternoon of fishing. Because of the scents are liquid based, there is a high risk that the scented mixture will be on the fishermen's clothes or skin.

Use of attractants to lure fish is known in the art. For example, in U.S. Pat. No. 4,888,907 to Gibbs attractant is contained within a fishing lure. The Gibbs device overcomes the problem of applying the attractant to the lure because the lure is manufactured and filled with attractant. However, the Gibbs device is limited to use of a single lure with a single attractant. For example, a fishermen would be unable to use what the fisherman believes is a more effective lure with a different scent. Without the capability to cross match attractants and lures, a fishermen's ability is unnecessarily limited.

An alternative, liquid attractant is described in U.S. Pat. No. 5,415,862 to Bethshears et al. The compound taught in Bethshears incorporates use of an oil-based liquid component, such as salmon oil or cod oil. However, without disclosing a method of application to a fishing line, Bethshears' '862 does not overcome the problem associated with the undesirable odor of such oils. A fishermen would be forced to apply the attractant by hand, which would result in an inefficient use, awkward handling of the lure, and risk of getting the attractant on clothes or skin.

Another attractant is described in U.S. Pat. No. 5,393,537 to Rawlins. Rawlins '537 teaches a compound which can penetrate the surface coating of a fishing lure or the body of live bait. A problem similar to that presented by Gibbs '907 is also apparent in Rawlins '537. After a fisherman has applied the compound described in Rawlins '537, he or she will not be able to use that lure with a different attractant, until the attractant dissipates. This is a significant problem because while the same lure may be used to attract different varieties of fish, the same smells may not.

Hence, there is a significant need for a scented compound that will attract fish, but that can be applied in an efficient manner as well as a manner that will not allow the scent to get on the fisherman's clothes or skin.

### OBJECTS OF THE INVENTION

It is an object of the present invention to provide a fish attractant which may be efficiently applied to fishing lures and live bait.

It is an object of the present invention to provide a fish attractant which will allow a fisherman to apply the attractant without having it spill, splash or leak on his or her clothes or skin.

It is an object of the present invention to provide an attractant applicator which will allow a fisherman to apply attractant without coming in physical contact with the attractant compound.

### SUMMARY OF THE INVENTION

The present invention is directed to an improved fish attractant which may be applied to a fishing lure or bait including live bait by a fisherman, without the fisherman having to contact the attractant compound. The present invention includes an applicator as well as the composition of the attractant.

The fish attractant may comprise one or more gelling agents, one or more emulsifiers, one or more humectants, one or more emollients and one or more active ingredients that are desired by a fish. The composition of the attractant has a pasty consistency that permits it to be applied to a lure by means of a brush, or an applicator. Preferably, the attractant of the present invention may be rubbed on a lure by an applicator that permits the composition to be applied without the user needing to touch the attractant. The attractant may have the following composition:
Gelling Agent 0.001-3%
Emulsifier 2.00-8%
Humectant 55-65%
Emollient 0.1-5%
Active Agent 3-8%
Remainder water

### BRIEF DESCRIPTION OF THE DRAWINGS

FIG. 1 is a cross-sectional view of an embodiment of the applicator of the present invention.

FIG. 2 is a side view of another embodiment of the applicator of the present invention.

FIG. 3 is a perspective view of a further embodiment of the applicator of the present invention.

FIG. 4 is a longitudinal section, with a small portion of the cap disclosed in side elevation, through a cosmetic applicator embodying the invention;

FIG. 5 is a longitudinal section taken along the line 2-2 on FIG. 4;

FIG. 6 is a cross-section taken along the line 3-3 on FIG. 5;

FIG. 7 is an enlarged fragmentary, longitudinal section of the region indicated by the circle 4 in FIG. 4.

### DETAILED DESCRIPTION OF THE INVENTION

The improved attractant of the present invention is designed to have a pasty or semisolid consistency so that it may be applied to the lure, bait, hook, line or other device used by the fisherman to lure a fish. The attractant may be applied by means of an applicator. In its simplest form, the applicator may have a tubular member of varying cross sections. While the cross section may be round, square or rectangular it will be appreciated that the cross section may be any appropriate shape. The applicator in this embodiment may be in the form of a paper, paperboard or plastic material. One end of the tubular member may be opened and the other sealed. In operation, the attractant rises from the opened end of the applicator as the body or tubular member is squeezed. In another embodiment the composition of the present invention may be applied by means for applicator having a tubular member with a drive means at one end for pushing the composition to the other or opened end. There are a number of different ways this can be accomplished.

In an alternate embodiment the attractant applicator comprises a body 10, which is preferably cylindrical. The body can house the fish attractant, shown generally at 11. At a bottom end 12 of the body, a base member 13 can be rotatably attached. As the base member 13 is rotated, a platform 16 within the body 10 can be raised. The vertical movement of the platform 16 may be accomplished if the platform has a threaded hole 15, through which a vertical, threaded rod 19 passes. The fish attractant may be disposed on a top surface of the platform. Thus, rotation of the base member may cause the attractant to be forced from a top end 17 of the body. As the attractant is exposed from the top end of the body, a fisherman may apply the attractant to a fishing lure or lure bait. The exposed portion of attractant is seen generally at 18. Also, the fisherman will not have to come in contact with the attractant because the body can be held while applying the attractant. Additionally, the top end of the body may be manufactured to allow for attachment of a cap 20. A cap 20 may prevent spillage or leaking of the attractant.

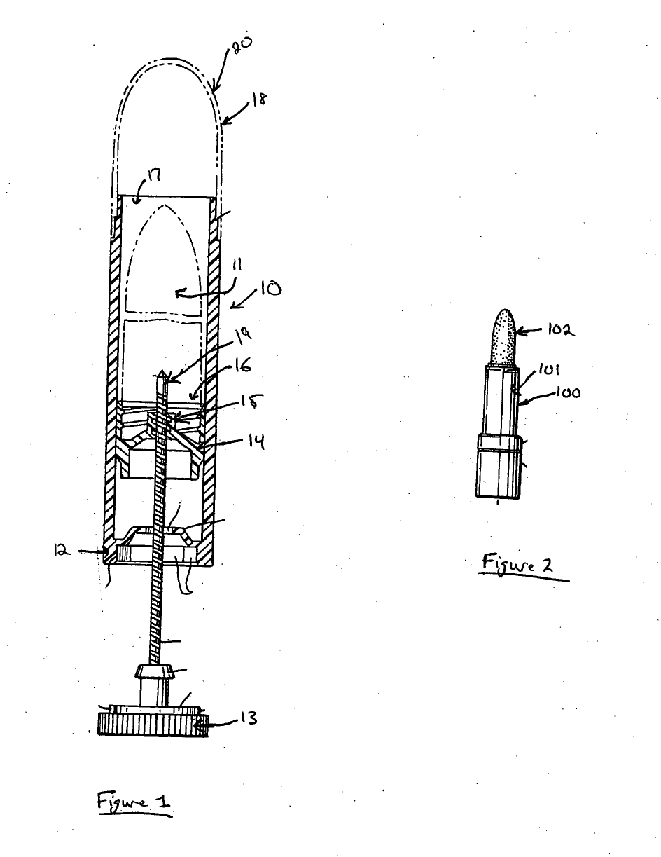

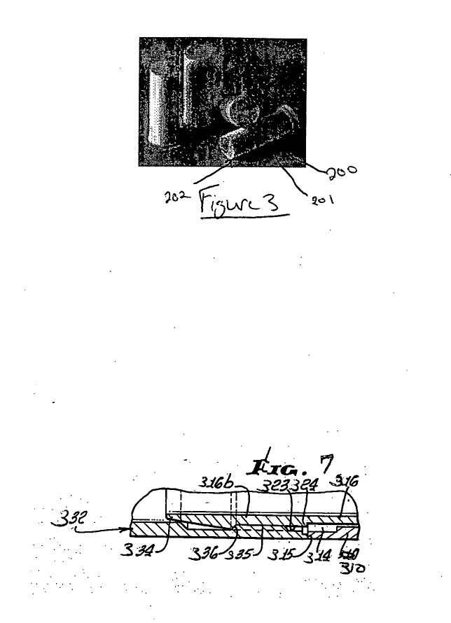

In an alternative representative embodiment seen in FIG. 2, the attractant applicator 100 may comprise a body 101, which is preferably soft plastic or rubber. A top end of the body can be equipped with an applicating means 102, such as a roller sphere or sponge. The body can be filled with attractant. If the fisherman wants to apply attractant to the lure or live bait, he may hold the applicator in a vertical disposition or at a downward angle, with the applicating means being at the lowest point. Gravity will allow the applicating means to gather attractant on it. Thus, if the applicating means is a roller, as the roller is passed over the lure or live bait, attractant is applied. Additionally, if the body is composed of soft plastic or rubber, a fisherman can temper the amount of attractant applied by applying compressive force to the body.

In a further embodiment, the attractant applicator may comprise a body, which houses attractant. On a top end, the body may have an opening with a threaded-neck. The threaded-neck can mate with a cap. On a inner surface of the cap can be an applicating means. Preferably, the applicating means is a stalk attached to the inner surface of the cap at one end and with a brush or bristles at another end. Also, the stalk should be sufficiently long enough to allow the brush to contact the bottom of the body. In use, a fisherman could apply attractant by allowing the brush to soak up an amount of attractant, and then sweeping it over the surface of the lure or bait.

A still further embodiment of the applicator of the present invention is seen in FIG. 3. The applicator 200 is seen as comprising a cap 201 which fits over the entire length of the body 202 of the applicator. This embodiment will further limit spilling and smearing of attractant on the user's clothes and skin.

Other types of applicators may be used with the invention and can include an outer tubular member having an internal helical groove, with a carrier sleeve disposed therein having two longitudinal slots opening through the forward end of the sleeve, the rearward portion of the sleeve terminating in a base. The tubular member and sleeve are substantially coterminous at their forward ends. A cup, in which the fish attractant is inserted, is disposed within the sleeve. This cup may have a pair of lugs or keys extending through the longitudinal slots into the helical groove, relative turning between the tubular member and carrier sleeve effecting forward advancing of the cup, to project the fish attractant beyond the forward end of the carrier sleeve, or retraction of the cup and fish attractant within the carrier sleeve, depending upon the direction of relative turning. When the fish attractant is not in use, the cup and fish attractant are in retracted position. An elongate protective cap is placed over the entire length of the tubular member and frictionally over a forward portion of the base to enclose the tubular member and the carrier sleeve, and the fish attractant therewithin, the cap projecting forwardly beyond the tubular member and carrier sleeve.

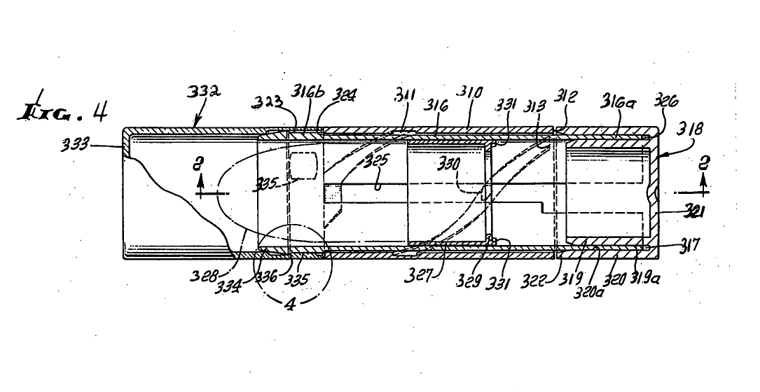

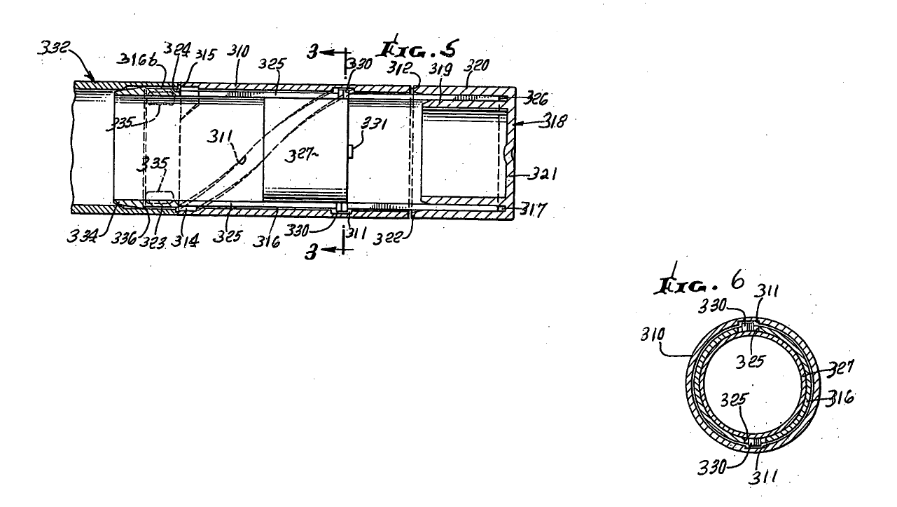

As seen in FIG. 4 the fish attractant applicator may also include an outer cylindrical tubular member 310 having an internal helical groove or thread 311 therein, such as a two-start thread or groove, the rear end of each thread or groove terminating short of the rear end 312 of the tubular member to provide a transverse stop 313. The forward end 314 of the thread or groove terminates or runs out at the forward end 315 of the tubular member.

Disposed within the tubular member is a cylindrical carrier sleeve 316 having a rear portion 316a extending beyond the rear end 312 of the tubular member and fitting within an annular groove 317 in a base portion 318 of the sleeve structure, the groove being defined between radially spaced inner and outer skirts 319, 320 extending forwardly from the end wall 321 of the base. The carrier sleeve 316 is initially separate from the base. When inserted in the groove 317, it makes a press fit against the confronting cylindrical surfaces 319a, 320a of the inner and outer skirts. The carrier sleeve may be secured to the base by welding it thereto, as through use of ultrasonic means. It is to be noted that the forward end 322 of the outer skirt terminates closely adjacent to the rear end 312 of the tubular member, the outer skirt preferably having substantially the same outside diameter as the diameter of the tubular member 310.

The carrier sleeve 316 has a forward circumferentially continuous portion or extension 316b in advance of the end 314 of the helical thread or groove. The extension has a periphery 323 greater in diameter than the main portion of the carrier sleeve to provide a shoulder 324 extending partially across the forward end 315 of the tubular member, thereby preventing substantial forward axial movement of the tubular member 310 with respect to the carrier sleeve 316. Rearward longitudinal movement of the tubular member 310 on the carrier sleeve is prevented by engagement of the tubular member 310 with the forward end 322 of the outer skirt. Thus, the tubular member 310 is confined for relative turning or rotation with respect to the carrier sleeve 316 and its base 318.

As specifically disclosed, the carrier sleeve 316 has a pair of diametrically opposed longitudinal slots 325 opening through at the rear end 326 of the sleeve and terminating at the sleeve shoulder 324. Disposed within the sleeve is a cup, socket or holder 327 adapted to have the rear portion of the cosmetic mass, such as fish attractant 328, mounted therewithin which bears against an inwardly directed cup flange 329. Integral with the cup are a pair of diametrically opposed lugs or keys 330 extending through the slots 325 for reception within the two-start internal helical thread or groove 311 of the tubular member 310. It is to be noted that engagement of the keys with the opposed sides of the slots 325 prevents the cup or holder 327 from partaking of any significant turning relative to the carrier sleeve 316. Accordingly, relative turning between the tubular member 310, on the one hand, and of the carrier sleeve 316, sleeve base 318 and cup 327, on the other hand, will result in longitudinal feeding of the cup and the cosmetic mass 328 secured therein along the carrier sleeve 316. Such relative turning in one direction will result in retraction or rearward movement of the cup within the carrier sleeve to the extent limited by engagement of the lugs or keys 330 with the stops 313 provided at the rear end of the helical groove 311. Relative rotation in the opposite direction will shift the cup 327 and fish attractant 328 in a forward direction to project the fish attractant beyond the forward end of the carrier sleeve extension 316b, the forward movement of the cup and fish attractant being limited by engagement of the lugs or keys 330 with the rear end of the extension.

The cup has a pair of diametrically opposite fingers 331 extending rearwardly beyond its flange 329, which frictionally engage the inner wall or surface of the carrier sleeve 316 to resist, but not prevent, longitudinal movement of the cup 327 along the carrier sleeve. Such resistance to movement is overcome by imparting sufficient torque to the tubular member 310 and carrier to secure their relative turning and advancing or retracting of the cut 327 and fish attractant 328 with respect to the carrier sleeve 316. The frictional engagement between the fingers 331 and the inner wall or surface of the carrier sleeve 316 prevents the cup 327 from moving inadvertently axially with respect to the carrier sleeve.

A cylindrical cap 332 having a forward end wall 333 is provided which is adapted to be slipped frictionally over the extension 316b and into abutting relation to the forward end 315 of the tubular member 310. for the purpose of enclosing the open end of the carrier sleeve extension and to protect the forward end of the fish attractant. The circumferentially continuous extension preferably has a tapered forward portion 334 which serves to guide the rear, open end of the cylindrical cap onto the extension 316b and place it in a position coaxial with the other members of the fish attractant applicator. The cap, which is made of an elastic material, is held frictionally on the extension by circumferentially spaced cap tabs 335 frictionally engaging the periphery of the extension. The cap may be removed by exerting sufficient forward pull thereon, the tabs being released by their engagement with the tapered or cam surface 336 on the extension which expands the tabs outwardly, permitting the cap to be shifted forwardly off the extension 316b.

The cylindrical cap 332, tubular member 310 and outer skirt 320 of the base have substantially the same external diameter. Since the cap extends over the carrier sleeve extension 316b only and terminates at the forward end 315 of the tubular member, it is not necessary to provide a cap of increased diameter for enclosing the tubular member 310. As a result, the applicator has a substantially smaller maximum diameter, producing its greater slimness. Since the cylindrical cap 332 is much shorter than prior fish attractant applicators of the type illustrated herein, there is a substantial savings in material. Moreover, the outside diameter of the base 318 is smaller than in prior devices, which also results in savings in material. The making of the base 318 separate from the carrier sleeve 316 enables the slots 325 to open through the rear end 326 of the carrier sleeve, permitting the forward extension portion 316b of the carrier to be circumferentially continuous. As a result, the slots 325 are not exposed to view, which enhances the appearance of the applicator upon removal of the cap. The shorter cylindrical cap of the present applicator also makes it less likely that its rearward rim portion will engage the fish attractant 328, in the event the latter is not fully retracted within the carrier sleeve 316, thereby insuring the maintenance of the cylindrical cap in a clean condition. Because of the use of the relatively short cylindrical cap 332 and its termination at the forward end of the tubular member 310, three cylindrical applicator surfaces are visible, all preferably of the same outside diameter. These are the cylindrical peripheries of the cap 332, tubular member 310 and outer skirt 320 of the base. It will be appreciated by those skilled in the art that there are numerous applicators that may be used to apply the fish attractant of the present invention and the present invention is not limited to any particular applicator.

The improved attractant of the present invention includes a gelling agent such as hydroxyethylcellulose, methylcellulose, hydroxypropylcellulose, and carboxymethylcellulose, guar gum, quaternized guar gum, nonionic guar gums comprising C.sub. 1-C.sub.6 hydroxyalkyl groups, xanthan, locust bean, scleroglucan, gellan, rhamsan, or karoya gums, alginates, maltodextrin, starch and its derivatives, hyaluronic acid and its salts, clays such as montmorillonites, hectorites, bentones, or laponites, polymers with a carboxyl group such as crosslinked polyacrylic acids which are at least partially neutralized, for example, “Carbopol” or “Carbomer” products from the company Goodrich (Carbomer 980, for example, neutralized with triethanolamine, abbreviated TEA), poly(glyceryl (meth)acrylate) polymers, polyvinylpyrrolidone, poly(vinyl alcohol), crosslinked acrylamide polymers and copolymers, crosslinked methacryloyloxyethyltrimethylammonium chloride homopolymers, associative polyurethanes, and mixtures thereof.

In addition to the gelling agent there is preferably one or more emulsifiers preferably anionic emulsifiers. In particular, certain salts of fatty acids are useful in the formulations of this invention. More particularly, the following anionic emulsifiers are useful in the compositions of this invention: sodium stearate, sodium laurate, sodium lauryl sulfate, DEA cetyl phosphate, dioctyl sulfosuccinate and the like. Most preferably, the emulsifier should be sodium stearate.

The composition may also include one or more humectants, such as sorbitol, glycerin, propylene glycol, or butylene glycol or combinations thereof. Also there may be one or more emollient in the product according to the invention, such as stearyl alcohol, glyceryl monoricinoleate, glyceryl stearate, glyceryl monostearate, propane-1,2-diol, butane-1,3-diol, cetyl alcohol, isopropyl isostearate, stearic acid, isobutyl palmitate, oleyl alcohol, isopropyl laurate, decyl oleate, octadecane-2-ol, isocetyl alcohol, cetyl palmitate, silicone oils such as dimethylpolysiloxane, isopropyl myristate, isopropyl palmitate, polyethylene glycol, lanolin, cocoa butter, vegetable oils such as maize oil, cotton seed oil, olive oil, mineral oils, butyl myristate, palmitic acid, etc.

In some embodiments, the composition may have one or more acids present including L-Arginine and L-lysine. Also present may be Hamameles Virginiana (Witch Hazel).

The composition is also provided with an active ingredient which is selected for the type of fish that is being sought. Preferred attractant's include but are not limited to anchovy, Craw daddy, garlic, crawfish, baitfish, crawfish, anise, shrimp, crab, claim salt, herring, sardine, salmon, shad, sturgeon, bunker, shedder crab, squid, anise, liquorice, fish blood, cricket legs or worm parts. The active ingredient should preferably be finely chopped or ground up or more preferably liquified in a blender or similar instrument.

The remainder of the composition is water, usually distilled water or more preferably deionized water.

The attractant may have the following composition:
Gelling Agent 0.001-3%
Emulsifier 2.00-8%
Humectant 55-65%
Emollient 0.1-5%
Active Agent 3-10%
Amino acid 0-1%
Hamamelis Virginiania 0-2%
Remainder water
   The amino acid can include any of the known amino acids. In a preferred embodiment, the amino acid is preferably one or more of the following: L-Arginine, L-Asparagine, L-Aspartic Acid, L-Cysteine, L-Cystine, L-Glutamic Acid, L-Glutamine, Glycine, L-Histidine, L-Isoleucine, L-Leucine, L-Lysine, L-Methionine, L-Proline, L-Phenylainine, L-Serine, L-Threonine, L-Tryptophan, L-Tyrosine, L-Valine. In a more preferred embodiment, the amino acid is L-Arginine or L-Lysine and mixtures thereof.

A more preferred embodiment may have the following composition:
Gelling Agent 0.1-3%
Emulsifier 3.00-7%
Humectant 57-62%
Emollient 1-4%
Active Agent 4-8%
Amino acid 0-1%
Hamamelis Virginiania 0-2%
Remainder distilled water or deionized water.

A most preferred embodiment may have the following composition:
Gelling Agent 0.3-1%
Emulsifier 4.00-5%
Humectant 57-62%
Emollient 2-3%
Active Agent 6-7%
Amino acid 0.25-0.75%
Hamamelis Virginiana 0.5-1.5%
Remainder distilled water or deionized water
   In an alternative embodiment a preferred composition is as follows:
Component Percent by weight (gm)
Methycellulose 0.001-4%
Sodium Stearate 2.00-10%
Glycerin 50-75%
Glyceryl Monostearate 0.1-8%
Licorice oil 3-10
Remainder distilled water or deionized water
   A more preferred composition is
Methycellulose 0.01-2%
Sodium Stearate 3.00-6%
Glycerin 55-65%
Glyceryl Monostearate 1-4%
Licorice oil 4-8
Remainder distilled water or deionized water.
   A most preferred composition is
Methycellulose 0.34 0.3-1%
Sodium Stearate 4.73 4-5%
Glycerin 59.80 55-65%
Glyceryl Monostearate 2.36 2-3%
Licorice oil 6.76 6-7%
Remainder distilled water or deionized water

### EXAMPLE 1

### Example

Methycellulose 0.001-3%
Sodium Stearate 2.00-8%
Glycerin 55-65%
Glyceryl Monostearate 0.1-5%
Licorice oil 3-8
Remainder distilled water or deionized water

The composition of the present invention may be made according to the following procedure:
1. Combine water and glyceryl monostearate and heat to 1000° C. until the glyceryl monostearate is melted.
2. Add in the sodium stearate by sprinkling small amounts at a time while stirring until all the sodium stearate have dissolved into the solution.
3. Add methylcelluose by sprinkling small amounts at a time while stirring until all the methylcelluose have dissolved into the solution.
4. Remove from heat and add the licorice oil while stirring.

### EXAMPLE 2

### Example

Methycellulose 0.3-0.4%
Sodium Stearate 4.00-5%
Propylene glycol 59-60%.
L. Arginine 0.25-0.75%
L. Lysine 0.25-75%
Hamamelis Virginiana 0.75-1.25%
Glyceryl Stearate 2.00-3.00%
Licorice Oil 6.00-7.00%
Balance distilled or deionized water

The composition of Example 2 may be formulated by
1) combining water and glyceryl monostearate and heating the mixture to about 100 degrees until the glyceryl monostearate is melted.
2) The sodium stearate may be added in by sprinkling small amounts at a time while stirring until the sodium stearate has dissolved in solutions.
3) Methyl cellulose is added by sprinkling small amounts at a time while stirring until dissolved into the solution.
4) The composition is removed from the heat and the licorice is added while stirring.
5) Package as desired and allow to cool.

1. A fish attractant composition comprising:
Gelling Agent 0.001-3%
Emulsifier 2.00-8%
Humectant 55-65%
Emollient 0.1-5%
Active Agent 3-10%
Amino acid 0-1%
Hamamelis Virginiania 0-2%
Remainder water

2. The composition according to claim 1 wherein said amino acid is L-Arginine.

3. The composition according to claim 1 wherein said amino acid is L-lysine.

4. The composition according to claim 1 wherein the gelling agent is methycellulose

5. The composition according to claim 4 wherein the methylcellulose comprises 0.001-4% of the composition.

6. The composition according to claim 1 wherein the emulsifier is sodium stearate.

7. The composition according to claim 6 wherein sodium stearate comprises 2.00-10% of the composition.

8. The composition according to claim 1 wherein the humectant is glycerin.

9. The composition according to claim 8 wherein the glycerin is present in an amount of 50-75% of the composition.

10. The composition according to claim 1 wherein the emollient is glyceryl monostearate.

11. The composition according to claim 10 wherein the glyceryl monostearate comprises 1-4% of the composition.

12. The composition according to claim 1 wherein the active ingredient is licorice oil.

13. The composition according to claim 12 wherein the licorice oil is present in an amount of 3 to 8% of the composition.

14. A composition for attracting fish comprising:
Methycellulose 0.001-3%
Sodium Stearate 2.00-8%
Glycerin 55-65%
Glyceryl Monostearate 0.1-5%
Licorice oil 3-8
Remainder water

15. A composition for attracting fish to a lure comprising:
Methycellulose 0.3-0.4%
Sodium Stearate 4.00-5%
Propylene glycol 59-60%
L. Arginine 0.25-0.75%
L. Lysine 0.25-75%
Hamamelis Virginiana 0.75-1.25%
Glyceryl Stearate 2.00-3.00%
Licorice Oil 6.00-7.00%
Balance water

16. A method of making a fish attractant comprising:
a) Combining water and glyceryl monostearate and heating the mixture to about 1000° C. until the glyceryl monostearate is melted.
b) add in sodium stearate by sprinkling small amounts at a time while stirring until all the sodium stearate have dissolved into the solution.
c) adding methylcelluose by sprinkling small amounts at a time while stirring until all the methylcelluose has dissolved into the solution.
d) Removing the composition from heat and adding licorice oil while stirring.
e) allowing the composition to cool.
